(19) United States
(12) Patent Application Publication
(10) Pub. No.: US 2005/0177380 A1
(43) Pub. Date: Aug. 11, 2005

(54) System, computer program and method for enabling individual client users to recruit, connect to, and manage a remote workforce through a shared network

(76) Inventors: Gordon William Pritchard, Richmond Hill (CA); Brian Scott Pritchard, Newmarket (CA)

Correspondence Address: MILLER THOMPSON, LLP, 20 QUEEN STREET WEST, SUITE 2500, TORONTO, ON, M5H 3S1, CA

(21) Appl. No.: 10/773,251

(22) Filed: Feb. 9, 2004

(51) Int. Cl. G06F 17/60

(52) U.S. Cl. 705/1; 705/26

(57) ABSTRACT

A system is provided which includes a remote agent network is provided which enables network clients or client users to recruit, select, manage and pay a plurality of remote agents for the provision of service communication services to their customers. The remote agent network consists of a central communication platform that includes a web server and a telephony server. A network application enables the network clients to recruit and select remote agents. The network application enables network clients to manage the provision of service communications by remote agents via an operating platform that forms part of the remote agent network. The operating platform enables the remote agents to access network client databases, and to take phone calls from the network client call queue. The computer program of the present invention includes the network application and the operating platform which is resident on a remote agent client computer. The invention also provides a method for enabling the direct management of the remote agents by the network clients.

### FIELD OF THE INVENTION

This invention relates in general to methods and technologies that enable the management of a plurality of individuals to engage in structured service communications. More specifically, this invention relates to a system, computer program and method that enables individual Client Users to recruit, manage and pay their own remote agent workforce for the purpose of engaging in structured service communications.

### BACKGROUND OF THE INVENTION

Call centers have become widespread. Many businesses use individuals working in the context of a call center to handle telephone calls, emails, faxes or other communications that arise in the course of the operation of the business. The nature of these communications can vary greatly. They may involve customer orders, customer complaints, product returns, support of a product, and so on. All of these communications are referred to in this disclosure generally as “service communications”.

These service communications are usually relatively structured. For example, many businesses want the individuals handling the service communications (usually referred to as “agents”) to have specific background information on a product or service; to commence the service communication in a particular way; to conduct the service communication in accordance with a particular order; to respond to specific customer questions or concerns in a particular way, usually based on scripted responses; to follow a particular workflow, for example, regarding escalation of complaints to a service manager; and so on. This is what is meant when the disclosure refers to the fact that the service communications are “structured”.

There are a number of prior art technologies that enable the management of the engagement of agents in service communications in a call center context. A call center usually denotes a specific physical location in which a plurality of personnel are engaged in providing service communication services to one or more clients.

There are numerous advantages to utilizing “remote agents” for service communication purposes. “Remote agents” are not usually located in a call center facility and therefore provide the savings of the relatively significant overhead usually involved in providing call centers. “Remote agents” often work out of their homes and are not employees. This enables the provider of the service communications, i.e. the business providing access to a network of “remote agents” (usually referred to as the service provider in this disclosure) to provide work flexibility to “remote agents” in exchange for lower wages. This in turn enables the service provider to share the benefit of the lower wages with the clients, and also to improve the cost structure of the service provider. An added benefit of a network of “remote agents” is that the “remote agents” will not usually unionize.

Prior art solutions exist for creating a network of remote agents, and enabling the management of remote agents via a central network for the effective provision of service communications to clients. For example, U.S. Pat. No. 6,320,956, issued on November, 2001 to Cherry, generally describes method of automatic call distribution (ACD) service to one or more remotely located agents trained to service calls for a plurality of client call centers, comprising the steps of receiving a customer-initiated telephone call at a call center, routing the customer-initiated telephone call through a long distance carrier to a voice switch, the voice switch transmitting an array of caller information relating to the customer-initiated telephone call to a network coordinator servicing a plurality of different call centers, the network coordinator identifying at least one remotely located agent trained and authorized to receive the customer-initiated telephone call for the call center, and the network coordinator routing the customer-initiated telephone call from the customer servicing central office to the designated remote agent.

It should be understood that in this disclosure “client” refers to the client who engages the service provider, and “customer” refers to the customers of the “client” with whom the remote agents engage in service communications.

It should be understood that the method described in '956 patent provides means for extending the resources available to one or more call centers by providing access to a network through a network coordinator. There are a number of disadvantages to this prior art solution. The '956patent contemplates a solution whereby a plurality of clients are given access to remote agents, where each remote agent is available to a number of different clients at any given time. No means is provided therefore for clients to dedicate to their own service communications to their own remote employees or specific remote agents connected to a network without the need for a “Network coordinator” as in the '956 patent. Another disadvantage of the solution described in the '956 patent is that it enables service communications only in the context of a call center. The remote agent network described in '956 does not permit non-call center staff (for example store personnel) to connect to the remote agent network to provide service communications. For example, the present invention allows personnel in geographically dispersed locations to send and receive voice and data communications on a unified network.

What is needed therefore is a more flexible and comprehensive solution for enabling the recruitment and management of remote agents connected to a remote agent network by the employee or contract personnel. There is a need therefore for a remote agent solution that enables clients to recruit from a resource of potential remote agents one or more particular remote agents who meet the particular requirements of the client. There is a need for a system that is flexible in the sense that it also accommodates clients who want remote agents to be assigned on a random basis. There is a further need to provide a remote agent solution that enables clients to, comprehensively control the remote agents connected to the network as though the remote agents where in fact the client's employees.

This is important to ensure quality and to update processes relevant to the service communications as efficiently as possible. This is important as with changes to the business of the client, changes to the service communication processes occur regularly. What is also needed is a system, computer program and method that enables remote agent management in a manner that simplifies transaction processing and human resource management operations in a solution that is less expensive and scaleable. What is also needed is a remote enabling network that enables clients to add a remote voice/data processing capability to their customer service operations without having to create their own remote network infrastructure.

### SUMMARY OF THE INVENTION

One aspect of the present invention is a remote agent network. The remote agent network enables Client Users to recruit, select, manage and pay a plurality of remote agents for the provision of service, communication services to their customers.

The remote agent network consists of a central communication platform that includes a web server and telephony server. A network application is provided on the web server which provides one aspect of the program of the present invention. One or more Client Users are given access to an administration facility linked to the network application. The Client Users define their remote agent requirements using the administration facility. A group of remote agents are linked to the remote agent network. One aspect of the remote agent network is a Client WAN that enables the recruitment, selection and management of a plurality of remote agents from the group of remote agents.

Another aspect of the present invention is a computer program resident on the computer associated with the remote agents, which computer program consists of an operating platform. The operating platform includes a proprietary operating system for creating a channel to the Client User systems to obtain customer data and to a telephony server for linking with a Client User call queue.

### BRIEF DESCRIPTION OF THE DRAWINGS

A detailed description of the preferred embodiment(s) is (are) provided herein below by way of example only and with reference to the following drawings, in which:

FIG. 1 is a resource diagram illustrating the resources of the present invention, in a particular embodiment thereof.

FIG. 2 is a system resource diagram illustrating the principal components of the system of the present invention.

FIG. 3 is a program resource diagram illustrating the principal resources of the computer program of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

One aspect of the present invention consists of a method that enables a “Client User” (a user of the system of the present invention who is a client, as defined above) to configure on a remote agent network a plurality of human resource and technological parameters such that the Client User is enabled to recruit, manage and connect to a dedicated remote agent work force from any computer linked to the remote agent network.

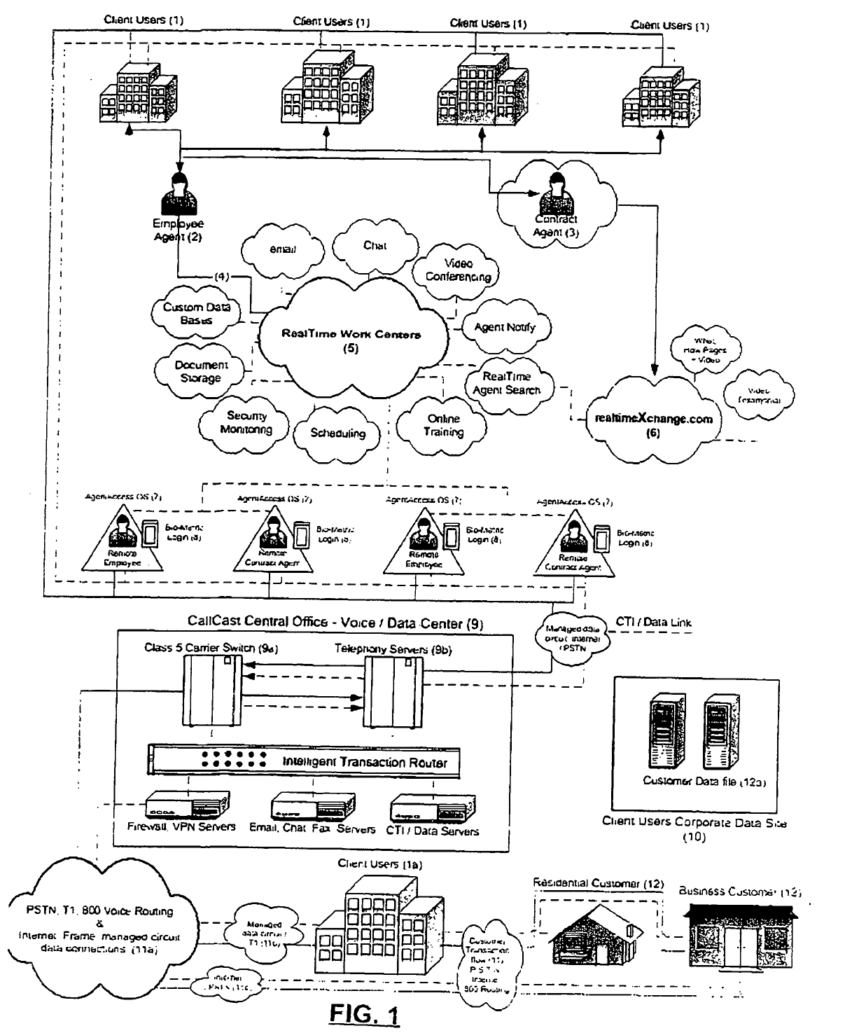

Another aspect of the present invention is the remote agent network 10 illustrated FIG. 1. The remote agent network 10 is best understood as a technology and communication platform that enables the interactions between Client Users 1 and Remote Agents particularized herein. The remote agent network 10 provides a series of tools that enable the Client Users to build and equip their remote agent workforce operations and then connect them into their daily stream of service transactions, and that enable the Remote Agents to conduct the service transactions defined by each Client User.

Client Users

The Client User 1 is generally a client who has signed a service agreement with the operator of the remote agent network 10. This agreement generally details the terms of access of the Client User 1 to the remote agent network 10 and covers billing issues, service levels, support and so on. One very particular aspect of the present invention is that Client Users 1, in one implementation of the present invention, are billed on the basis of the amount of their live time utilization of the various resources of the remote agent network 10 by the Client User 1, including their remote agent workforce (i.e. the remote agents that they have selected on the remote agent network 10 and conducted service transactions for the Client User 1).

The remote agent network 10 is provided in a scaleable manner such that it can accommodate virtually any number of Client Users 1 and virtually any amount of service transaction volume that the generate. One of the main limitations of the use of the prior art solutions in operation is the intrusion of the Network coordinator in the independent usage of each Client User's human resources. This issue is resolved by giving direct control to each Client User in the various stages of their remote agent workforce deployment.

Specific Implementations of the Invention

As illustrated in FIG. 1, the remote agent network 10 enables the Client User to use the remote agent network 10 to interact with service communication personnel who are not only located in different locations, but also may constitute a plurality of different groups, for example, service agents who are employees of the Client User, and others who may be hired on contract (referred to as “contract agents” in this disclosure). Contract agents enter into a licensing agreement with the operator of the remote agent network 10 regarding access and use of the network including associated technologies. The Contract Agents also generally enter into an agreement directly with Client Users.

“Remote agents” in this disclosure usually refers to service agents who are contract agents and are at a location remote from the Client User, e.g. they work out of their own homes. However, it should be understood that the remote agent network 10 of the present invention enables the service communication interactions, and the management thereof, with service agents who are in fact not contract agents. The word “remote agent” in fact incorporates also contract agents working from the remote agent network.

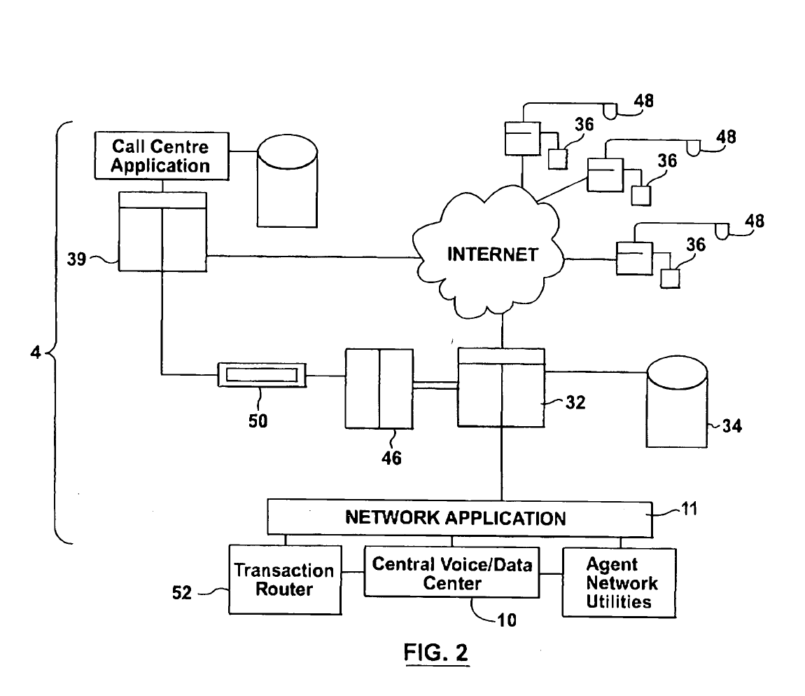

These different options defined by the human resource relationships that are supported by the remote agent network 10 are reflected in a series of different configurations or process routes which are best understood by reference to FIG. 1. These configurations are managed by means of the client administration facility 12 shown in FIG. 2. As shown in FIG. 2, the remote agent network 10 is linked to a network application 11. The network application 11 is best understood as a series of software and middleware utilities that enable the functioning of the aspects of the remote agent network 10 described herein, provided in a manner that is known.

One of the resources of the network application is a client administration facility 12. The client administration facility 12 is best understood as a known utility that enables the various Client Users to select and dynamically alter the service parameters of the remote agent network 10 as it relates to the provisioning of the particular Client User. In one particular implementation thereof, the administration facility 12 is best understood as a utility that enables the management of a client Intranet 14 that is provided based on known technologies in a manner that is also known. Further details of the operation of the client administration facility 12 are provided below.

The configurations of the remote agent network 10 defined by the client administration facility 12 include the following:

1. A Client User who wishes to create their remote workforce exclusively from their own employees takes the process route illustrated in FIG. 1 as the Employee Agent Access Route 2.

2. A Client User who wishes to create their remote workforce in some part with Contract Agents takes the process route illustrated in FIG. 1 as the Contract Agent Access Route 3.

Not all businesses need to deploy a remote work force. Some companies may want to simply augment their present in-house voice/data system to a full “enterprise” system that accommodates all their locations. Although this is a less complex configuration and is not the primary design of the remote agent network 10 of the present invention design, it is a practical outcome of the operation of the remote agent network 10. Accordingly, the following third process route also exists:

3. A Client User who wishes only to create their own “enterprise” voice/data switching system takes the Switch Access Route 4.

The Real-Time Work Centers

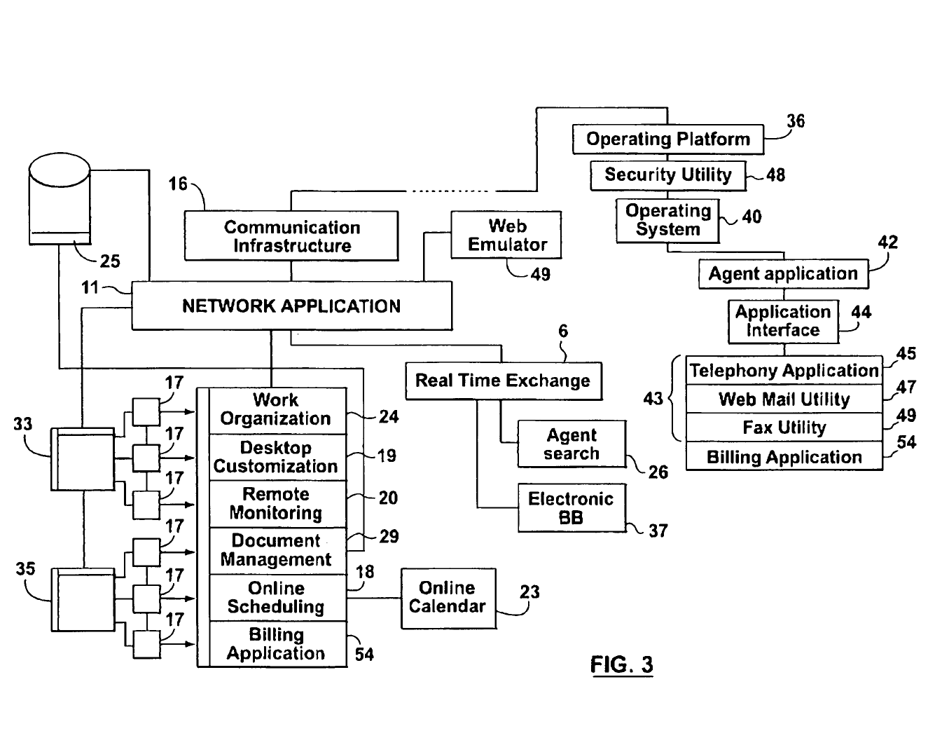

The Real-Time Work Center (best illustrated in FIG. 3) is best understood as a utility of the network application 11 run on the web server 32 described herein. The Real-Time Work Center is a web-based system that provides a series of customizable work organization and communication tools for enabling Client Users and their remote agents to provide for the day-to-day functioning of the remote agent work force of the present invention.

The Real-Time Work Center is provided by the network application 11 in two principal configurations: (1) a Client User Real-Time Work Center 5, and (2) a Remote Agent Real-Time Work Center 15. The interfaces and utilities linked with each principal configuration generally correspond, except the Client User Real-Time Work Center 5 enables the management of Remote Agents via the Remote Agent Real-Time Work Center 15, and the Remote Agent Real-Time Work Center 15 is geared toward the remote agents provide service communications to particular Client Users.

It should be understood that the network application 11 enables the operator of the remote agent network 10 to customize numerous aspects of the operation of the Real-Time Work Center to the particular needs of Client User, in a manner that is known.

The administration facility 12 described below enables the Client Users to control the various functions of the Real-Time Work Center.

In one particular implementation of the present invention, each Client User receives their own custom corporate branded version 17 of the Real-Time Work Center. Remote Agents that contract with that Client User to perform services become “members” of the Clients Real-Time Work Center 15.

The Real-Time Work Center 15 enables Client Users to control the remote agent work day directly without the need of a “Network Coordinator” as in the prior art solution.

Client/Remote Agent Personal Management Tools

One aspect of the Real-time Work Center 15 is a customized desktop 19 which is provided to Remote Agents. The customized desktop 19 provides access to the Remote Agents to a series of support and self-management tools. These tools are based on well-known utilities, modified to conform with the specifications described in this disclosure, in a manner that is well known to those skilled in the art.

Collaboration Tools

The present invention contemplates the customized desktop 19 providing access to a series of known collaboration utilities 21 that enable the Client Users (for example a manager) to collaborate with remote agents, and also for remote agents to collaborate with other remote agents in execution of tasks for their Client Users.

Another known utility that can be described as a “collaboration tool” is an online calendar 23. The online calendar 23 is a standard calendar interface that is linked to the functions of the online scheduling utility 18 described below. Accordingly, the online calendar 23 enables remote agents to schedule their shifts for particular Client Users, and Client Users to control their remote agent requirements, but also enables Client User personnel and remote agents to collaborate in their scheduling activities.

A still other known utility that can be described as a “collaboration tool” in the context of the present invention is a contacts directory 25 which provides hierarchical access to contact information for specific “members” (whether Client User managers., network administrator personnel, or remote agents). This contacts directory 25 enables easy communication between members over the remote agent network 10. The contacts directory 25 and access thereto is administered by operation of the administration facility 12. The contacts directory 25 is linked to the web mail utility 47 and fax utility 49 described below.

The present invention also contemplates the integration of well-known polling applications and wireless device synchronization utilities (not shown) to better enable collaboration between members. These utilities are provided and integrated into the disclosed invention in a manner that is known.

Communications Tools

Chat workrooms automatically launch after login to provide an “always open” door for easy collaboration between Client User managers and their remote agents. Web mail is provided by operation of the web mail utility 47 described below. Other features include : Group Announcements, Online Discussions, MailBox, Wireless Access, and other similar utilities.

Productivity Tools

The present invention also contemplates the incorporation into the network application 11 of various productivity tools for deployment by operation of the Real-Time Work Centers, including Task Managers, Group Links, and Extranet Options.

Admin & Security Tools

The present invention also provides for various means for ensuring the security of Client User data including Secure Member Access, Permissions System, Member Groups, Secure Hosting, and SSL Encryption. In addition, in a particular embodiment of the present invention, an authentication utility 48 is described below to ensure that only authorized remote agents can connect to the remote agent network 10 and thereby gain access to client user data.

Database Creator & Manager

The Database Creator & Manager allows Clients and remote agents to organize, store and share important business information with ease. For example, the present invention contemplates inclusion of a known database management utility 29 which enables the management of the document storage system 28. The database management utility 29 enables databases and documents to be created and posted to the various remote agents. These documents include, for example, scripts for asking questions from, or responding to questions of, customers of Client Users; manuals for providing customer service on particular products or services of Client Users.

The database management utility 29 allows Client Users to quickly and easily:
Create-customized databases;
Create databases from a plurality of Database Solution Templates stored to the document storage system 28;
Sort, group and filter data for multiple views;
Format database reports for printing;
Import and export data to save time and increase accuracy; and
Access data instantly, 24 hours a day, 365 days a year.

Every Client Real-Time Work Center is equipped with a standard set of self-customizable databases templates to begin.

In a particular implementation of the present invention, the Client User Real-Time Work Center enables the Client Users and remote agents to access a number of functions that are best understood as customizable routine templates run on the Real-Time Work Center. These routine templates enable management of service communications by the Client Users. For example:

Agent Observe

Agent Observe gives Client Users a template to request the random recording of remote agents on calls from the telephony server 46 (described below) for training and quality assurance purposes. In a particular implementation of this feature, Client Users are enabled to score the call and send a direct link to the data record via email. Remote Agents are enabled to review their voice recordings, scores and coaching points. Client Users are enabled to customize the score sheet questions, point values, action lists and coaching points.

Asset Manager

The Asset Manager template enables Clients and remote agents to maintain a detailed inventory of anything—from computer hardware and merchandise. A field is provided to upload a picture of each item in the Asset Manager. Client Users are enabled to customize the fields and views based on the items that they desire to catalog.

Customer Relationship Manager (CRM)

The Customer Relationship Manager (CRM) template allows Client Users and remote agents to store and retrieve information about people. It can be used as a customer contact list in which to keep track of interaction with Client Users' clients, a donor list for Client Users' non-profit organization or event, or a class roster. By simply changing field names, or adding, deleting, or rearranging fields, Client Users can create a custom contact list to suit specific needs. Client Users are enabled to use the Activity Log to track communications with contacts.

Event Registration

Client Users are enabled to use the Event Registration template to track registration information for meetings, seminars, conferences, trade shows, classes, sporting events, club functions, or corporate event. This template includes two, related databases: one for keeping track of event details such as time, location, and description, and one for tracking the attendees of each event. Client Users are enabled to monitor event capacity and registration fees for attendees.

In/Out Board

The In/Out Board helps keep track of members' whereabouts, improving office/remote productivity and efficiency. Instantly view co-workers'/members status to see if they are in or out, at lunch, in a meeting, on vacation, or out sick. Click on a member name to look up contact information for that person.

Issue Tracker

The Issue Tracker template provides a ready-made database where Client Users/remote agents can log problems and inquiries, and assign trouble tickets for Client Users/members to track. Client Users can customize this template as a starting point based on the practices their company uses to prioritize and follow up on inquiries.

Knowledge Base

The Knowledge Base template allows Client Users to easily create, maintain, and share company knowledge, either internally or externally. Some popular applications for this database include an IT Help Desk, a Client Customer FAQ List, a Self-Service Training Center, and a 24×7 online Technical Support line. Search the knowledge base to get immediate answers to all product or support questions.

Sales Forecasting

Client Users may use the Sales Forecasting template to get instant snapshots of sales pipeline, empowering Client Users and sales teams to stay ahead of rapidly changing situations. With a Sales Forecasting database Client Users can review the status of each sales opportunity, keep historical data of sales activity in the Activity Log, print forecast information, or export sales data to a spreadsheet for additional analysis. It is a great tool for managing your prospect activity. Since all the fields and views are customizable, Client Users can easily tailor the database to match their company's unique forecasting process.

Time Sheet

Client Users may customize the Time Sheet template to create a custom database where Client Users/remote agent members can track billable and non-billable time spent on, projects, and activities.

In an example that illustrates the operation of the present invention, Client Users begin the enabling process by entering a client username and password assigned by the operator of the remote agent network 10 via a standard log-in interface provided by the client administration facility 12 in a manner that is known. By providing the username and password, authorized personnel of the Client Users can gain access to the client Intranet 14.

As shown in FIG. 2, the remote agent network 10 includes a communication infrastructure or communication utility 16. The constituent elements of the communication utility 16 in a representative implementation thereof are detailed below.

Also as shown in FIG. 2, one aspect of the communication infrastructure of the present invention is that the client Intranet 14 provides to the Client User a private communication channel using live Chat, video, person to person and group conferencing that connects the Client User with their remote agents. The client Intranet 14 is best understood as a communication hub that permits remote agents and the various Client Users to interact. It also links the client's remote agents (and all remote agents) together in an interactive, online community.

One aspect of the network application 11 is a customizable interface that enables the Client Users to manage their utilization of the resources of the remote agent network 10. This customizable interface is shown in FIG. 1 as the “Real-time Work Center” 5.

One of the features of the Real-Time Work Center 15 in its Client User iteration is a customizable interface provided to Client Users that enables management of the aspects of the client Intranet 14 pertinent to the particular Client User.

The Real-Time Work Center 15 in its Client User iteration organizes access to a comprehensive set of management tools necessary for the real-time care and control of a remote agent work force. These tools are particularized below. In one representative embodiment of the Real-Time Work Center 15, it is provided in a known WINDOWS™ interface with a series of drop down menus provided in a manner that is known.

Client Users choose their own configuration of the Real-Time Work Center 5 from a menu of available management tools. These tools are illustrated in FIG. 3. The tool menu includes (in this representative embodiment) means for accessing the following utilities: an on-line scheduling utility 18, remote monitoring utility 20, chavvideo management utility 22, work organization utility 24, agent search utility 26. The Real-Time Work Center 5 also provides an interface to the document storage system 28 and the Real-Time Exchange 6.

The on-line scheduling utility 18 enables the remote agents to provide the times when they are available for handling calls; and enables Client Users and managers of the remote agent network 10 to book remote agents for particular time slots. In a particular preferred embodiment, first the remote agent builds their weekly/bi-weekly profile of work availability in ½ hour intervals and posts it to the on-line scheduling utility 18. Second the Client User enters anticipated transaction volumes to be processed in ½ hour intervals. The on-line scheduling 18 utility calculates how many remote agents will be required to process the anticipated transactions. The Client User reviews and adjusts the recommended head count if required. The Client User submits the final headcount to the on-line scheduling utility 18. The on-line scheduling utility 18 builds individual schedules from the remote agents' availability profiles in ½ hour intervals in a manner that is known by means of a matching routine of Client User requirements to availability of particular remote agents. The on-line scheduling utility 18 then returns the confirmed final work schedule to the individual remote agents and a final confirmation headcount fulfillment to the Client User.

The on-line scheduling utility 18 thereby enable schedules to be created for remote agents. The on-line scheduling utility 18 also enables remote agents to check their schedule, place scheduled shifts that a remote agent can no longer keep on a live swap board, in a manner that is known, create alarms and reminders and so on. For this purpose, the on-line scheduling utility 18 is accessible through the operating platform described below, or via a browser loaded to the remote agents' computers.

The Real-Time Exchange

Client Users choosing to use Contract Agents are able to recruit their workforce through the resources of the Real Time Exchange 6. The Real Time Exchange is a web site 31 that, in a representative embodiment of the present invention the web site 31 is hosted on the web server 32. The Real Time Exchange 6 is best understood as a web enabled electronic labor exchange, provided in a manner that is known. By operation of the administration facility 12, the Real Time Exchange 6 provides a labor exchange for Client Users to search and locate Remote Agents linked to the remote agent network 10 that meet the particular requirements of the Client User.

The web site 31 includes an agent area 33. The agent area 33 is accessible to all prospective Contract Agents recognized by the operator of the remote agent network 10. The site provides an on-line template for a multi-media e-resume (photo, text, sound) that every prospective Contract Agent is required to complete in order to participate in the electronic labor exchange process. Completed e-resumes are stored on the database 34 linked to the web server 32.

The web site 31 also includes a Client User Area 35 which enables Client Users to perform searches of current “member” Contract Agent databases or to post their requirements to prospective Contract Agents by means of an electronic bulletin board 37 that is provided in a manner that is known. Specifically, in one particular implementation of the present invention, the Client Users provide their eligibility requirements in a form provided by the web site 31. The network application 11 automatically publishes the requirements to the web site 31 in a manner that is known.

In one particular aspect of the present invention, the network application 11 prescreens the Contract Agents by analyzing the eligibility requirements of Client Users and comparing these requirements to the qualifications of Contract Agents or prospective Contract Agents linked to the remote agent network 10. The Agent Area of the web site 33 thereafter only shows eligibility requirements of Client Users whose eligibility requirements are met by the particular Contract Agent. Example of eligibility requirements includes knowledge of a particular language, or years of experience as a Contract Agent.

Once a Contract Agent eligible to fill out a particular Qualification e-form fills out a particular Qualification e-form, the e-form is passed on by the network application 11 directly to the Client User. This is an important aspect of the present invention that enables the Client User to control their contract agent workforce by directing their recruitment. Client Users can arrange for telephone or in person interview as they may require.

In one particular implementation of the present invention, once a Client User has determined that one or more Contract Agents have met their requirements, the Contract Agents are invited to join a Client User training course. The training course is usually designed jointly by the Client User and the operator of the remote agent network 10. Training consists of a combination of on-line learning and in class time. The execution of training is generally provided by the Network operator or the Client User, or both jointly, depending on the specific requirements of the Client User.

The Client User Area 35 of the web site 31 provides a link to the functions of the agent search utility 26. The agent search utility 26 enables the Client User to search for submitted e-resumes.

The Real Time Exchange 6 enables the Client Users to simply and quickly build their own remote Contract Agent workforce without the expense of recruitment and without the restriction of geographical limits.

Agent Access Operating Platform

For a remote agent workforce to effectively process voice/data transactions for Client Users, a secure, seamless and uniform communication and operating platform is desirable that links the remote agents the contact center operations of the Client User, and specifically the Client User's voice and data work stream.

In accordance with one particular aspect of the present invention, a common proprietary operating platform 36 is provided to each Contract Agent. The operating platform 36 is also an aspect of the computer program of the present invention. The operating platform 36 is loaded on each computer that is connected to the remote agent network 10. In particular, the operating platform 36 is loaded on the computer or computers used by the Remote Agents.

In one particular embodiment of the present invention, the operating platform 36 includes a proprietary operating system 40 and an agent application 42. The operating system 40 is a LINUX™ based operating system provided in a manner that is known.

The operating platform 36 resides on the boot disc of the computer. In a particular implementation, the operating platform 36 is stored to a compact disk or some other computer readable medium. When the disk boots up, the operating platform 36 loads into the RAM and not the hard drive of the computer. During the install, a secure partition is built between the operating platform 36 software running from the RAM on the computer and the computer's hard drive. This isolates the resident installed PC's hard drive and operating system from access thereby securing Client User data accessed by the Contract Agents via the link with the remote agent network 10.

With the operating system 40 in full control the computer, it is converted by the operating system 40 into a VPN secure, remote workstation with IP packet control of the Remote Agents' state on the carrier switch 50, in this particular implementation a P.S.T.N. Class 5 Carrier Switch.

The agent application 42 includes a series of communication utilities and interfaces 43 necessary to connect to the remote agent network 10 as described herein, and also to connect to the client application 39. The agent application 42 also includes the telephony application 45 described below, which enables the Contract Agents to handle telephone calls for Client Users. The agent application 42 also includes a known web mail utility 47 for accessing emails sent to Client Users, and responding to same where this is required by the particular Client User. The agent application 42 also includes a fax utility 49. The agent application 42 still further includes an agent application interface 44 that enables the Remote Agents to control the functions of the client application 38 from the Remote Agent's computer. These functions include for example accessing certain call templates, documents for responding to customer queries, and so on.

The Client User generally uses a client application 38 associated with a client server 39 for their call center functions. The client application 38 may include, for example, call center software. One aspect of the present invention is that the operating platform 38 is adapted to connect the computer of the Remote Agent to the client server 39 and thereby the client application 38 as particularized herein. Specifically, the operating platform 36 connects to the remote agent network 10 of the present invention and then the remote agent network 10 provides a secure connection to the client server 39. Provided that the client application 38 is web enabled, the Remote Agents can interface with the client application 38 directly. Alternatively, a web emulator 49 is used to create a web-enabled version of the client application 38 in a manner that is known to those skilled in the art.

It should be noted that by interaction of the Remote Agents with the client application 38, the Remote Agents could store data to a client database (not shown) of the particular Client User.

On start-up, the agent application interface 44 fills the PC screen and displays the customized desktop 19 described above. The customized desktop 19 provides access to the tools and applications required for the remote agents to connect into the Client User's voice/data system. Specifically, the operating system 40 loads the telephony application 45 which is a softphone application that is part of the agent application 42. The softphone application is a known software utility that enables the remote agent to control its state, i.e. whether s/he is logged in, available to take a call, unavailable, hold, transfer connect, conference, hang-up, and automatic speed dial lists, etc in the Client User queues on the carrier switch 50 which in one particular implementation is a class 5 carrier switch, provided in a manner that is known. A live video link circuit is also launched, this provides visual authentication of remote agents and also provides an audiovisual communication and monitoring tool between remote agents to remote agents and remote agents to their Client managers.

The operating platform 36 connects the remote agent into the telephony server 46 that is connected to the remote agent network 10. The operating platform 36 also connects the remote agent via a CTI (Computer Telephony Integration) data link into the Client User's customer database record information that is linked to the client server 39. This allows the customer records to be routed with the individual calls and displayed in the agent application interface 44 of the answering remote agent at the same time as the call arrives.

Calls are routed to the telephony server 39 in a manner that is known to establish a call queue. Upon login, the remote agent is automatically put in the correct client queue, with the customer data and softphone control application open, ready to process calls, email, webchat, faxes & transactions. In this manner, the present invention enables surplus calls from a Client User call center to be routed to remote agents connected to the remote agent network 10.

Security Utility

A known security utility 48 is used to ensure that only authorized remote agents can access the remote agent network 10 and thereby data belonging to the Client Users. One particular implementation of the present invention includes an authentication utility or security utility 48 that is a biometric identification facility. For example, remote agents can be provided with a fingerprint scanner device which is connected to their computer. The authentication utility 48 compares a fingerprint scan obtained from the remote agent with an encrypted and secure file containing fingerprint data for the remote agent. In one particular implementation of the present invention, the fingerprint scan data is stored to the compact disc provided to the remote agents, i.e. each agent is provided a personalized compact disc.

On each disc boot-up, before a remote agent can login he/she must go through a fingerprint login scan by operation of the security utility 48. Only if the fingerprint scan matches the one embedded on the disc can the agent gain entry.

By this process Client Users are assured that only their remote agents have access to their transaction stream.

The Voice/Data Center

The transaction flow generated by the customers of Client Users and processed by the Client Users remote agents is controlled and physically connected through the remote agent network's 10 Central Voice/Data Center 9. The Central Voice/Data Center 9 is best understood as a central resource management utility for managing the allocation of resources available on the remote agent network 10. The Central Voice/Data Center 9 is the junction where the transaction demand side (the customer calls) is dynamically matched with the supply of human resources (the remote agents) waiting to process the transactions, i.e. the service communication requirements. The typical event for an inbound customer call involves the following sequence:
1. The customer call is switched (or diverted) from the Client User's contact center to designated ports on the Class 5 voice switch 50 (shown in FIG. 1) in the CallCast voice/data environment. The designation of the port identifies the remote agent's current status of availability generally to a 1-second refresh rate.
2. The voice switch 50 then identifies the next waiting remote agent from the queue of agents logged-in for calls from that port and gives him/her access to the call.
3. Simultaneously, the switch gathers the customer's service information from the client server 39 and directs it to the designated remote agent so he/she is equipped with the specific customer data information which is automatically popped up on their work screen ready for call processing.
4. The remote agent processed transaction is then switched back to the client server 39 or corporate facility for fulfillment.

All this is executed within the Central Voice/Data Center 9 configuration of voice/data switching, routing and database components specifically designed for the purpose. The following describes these components and the. contribution each makes to the event sequence.

1. The Class 5 Voice Switch

The voice switching in the present invention is handled by a Class 5 central office voice switch 50 that serves the local public switching network as an end office. The voice switch 50 is connected to the live database of the Intelligent Transaction Router 52 and the Telephony Server 46.

2. Telephony Server

The telephony server 46 allows a remote agent to log into a port on the telephony server 46 using IP signaling from the graphic user interface of the remote agent's softphone application that is part of the agent application 42. The Telephone Server 46 dials a connection to that agent using public telephone lines. The Telephony Server 46 is hard wired to the Class 5 Carrier switch using dedicated T1 connections. This allows the Class 5. Switch 9a (as illustrated in FIG. 1) to associate a dynamic or dedicated port within an ACD (automatic call distributor) queue configured on the Class 5 Carrier Switch 9a to the remote agent port on the Telephony Server 46.

Once this login is complete, the remote agent (using the softphone graphic user interface) has the ability (via IP signaling to the Telephony Server 46) to control their state within an ACD queue on the Class 5 Carrier Switch using a public telephone line connection. Typical remote-controlled functions include: (i) “LOGGED IN”; (ii) “AVAILABLE TO TAKE A CALL”; (iii) “LOGGED IN”; (iv) “AVAILABLE TO TAKE A CALL”; (v) “UNAVAILABLE”, (vi) “HOLD”, (vii) “TRANSFER CONNECT”; (viii) “CONFERENCE”; (ix) “CONFERENCE” (x) “HANG-UP”; (xi) “SPEED DIAL LIST”.

The Telephony Server 46 is also able to identify the remote agent on the Class 5 Carrier Switch 50 allowing CTI (Computer Telephony Integration) functions to take place. CTI is the ability of the Intelligent Transaction Router 52 to retrieve customer data records from the Client User's client server 39 and the corporate data server (or equivalent) linked thereto.

The Telephony Server 39 identifies which ACD port the remote agent is logged into and which IP data connection is required for customer information transfer between the Intelligent Transaction Router 52 and the remote agent. This capability enables the calling customer's data records to arrive on the remote agent's computer at the same time the call is presented to the remote agent.

One of the advantages of the present invention is that its particular configuration of the telephone server 46 makes a high performance voice and data connection path available to remote agents located anywhere in the world using a simple Internet and public telephone line connection.

3. Intelligent Transaction Router

The Intelligent Transaction Router 52 is best understood as a utility that includes a plurality of routines that enables the dynamic selection of which remote agent actually receives which call and/ or transaction type. The selection is determined by matching the qualification profiles (skills, training, priority etc. as established by the Client User) of their queued remote agents with the Client users call types or transaction types to be processed. The call or transaction types being established by rules set by the Client user in the ITR. The Client Users store the qualification profiles of their remote agents on the ITR database.

4. Client User's Corporate Data Site

As stated earlier, in one of the aspects of the remote agent network 10, the remote agents are given access to the client server 39, including the Client User's data center or corporate data site. The corporate data site may be located anywhere. It generally includes information that can assist the processing of a transaction—customer buying history, shipping address and credit card information etc. When a customer is identified (using rules set by Client users on the Intelligent Transaction Router 52) the specific customer data file is retrieved from the database and sent to the assigned remote agent by application of the remote agent identifying technology and rules resident in the Telephony Server 46 and the Intelligent Transaction Router 52. The data path between the Corporate Data Site and Central Voice/Data Center 9 is by data frame relay or managed circuit.

5. Customer Transaction Flow

The customers 12 of Client Users either initiate in-coming transactions (calls/e-mails/chats/faxes) or are recipients of the Client Users outbound transactions. Transactions may come direct into the Central Voice/Data Center 9 via the public service telephone network (PSTN), or by T1, 800 voice routing, internet, frame, or managed circuits 11a.

For maximum flexibility Client Users have the ability to choose multiple voice and data transmission methods.

Transactions may first go to the Client User's contact center where they are switched through by managed T1/frame connections 11b to the CallCast Voice/Data Center 9. Or calls may be percentage allocated by 800 routing 11 before reaching the Client Users ACD and directed through a common carrier to the Central Voice/Data Center.

Alternatively the Client user may choose to directly point transactions to the Central Voice/Date Center 9 using Internet and PSTN 11c connections.

The Remote Agent Invoice and Collection Method

In order to keep administration costs low for Clients Users, and to ensure the timely payment of remote agents, another aspect of the present invention is a remote agent invoice and collection method. In accordance with this method, remote agents contract and pay a billing third party to prepare billing invoices and collect monies for work performed based on their work contracts with their Client Users.

Remote agents authorize this billing third party to access their work data records in the Central Voice/Data Center 9 which prepares records of the work performed by the remote agent for their Client User.

An invoice is automatically generated for each remote agent on the 1^{st} and 16^{th} of each month. Remote agents sharing the same Client User are grouped together by remote agent line item creating a master invoice for each Client User. The billing third party emails the master invoice to each Client User. The Client User reviews the master invoice by comparing it to each remote agent's work records in the Central Voice/Data Center 9. Client Users use electronic payment or check to transfer payment for the remote agents' master invoice to the billing third party within the predetermined payment period, for example 10 business days. Overnight, the billing third party transfers payment for each remote agent's invoice directly into their designated bank accounts using direct electronic transfer.

These functions are provided by a remote agent billing application 54 provided in a manner that is known.

Advantages

One of the aspects of the present invention is that any computer with access to a telephone line and preferably a high-speed internet connection is eligible for instant conversion to a remote enterprise voice and data workstation. Client Users and remote agent workers are able to enter and carry on a highly productive day-to-day work relationship without ever meeting each other directly. The present invention provides flexibility to Client Users in enabling the quick expansion or contraction of service communication resources. The present invention allows the Client Users to deploy quality services to customers with minimum investment.

Other variations and modifications of the invention are possible. All such modifications or variations are believed to be within the sphere and scope of the invention as defined by the claims appended hereto.

1) A method of engaging a plurality of individuals for the provision of service communications to customers, comprising the steps of:
a) Providing access to a remote agent network to one or more client users;
b) Providing access to the remote agent network to a plurality of remote agents; and
c) Enabling the one or more client users by operation of the remote agent network to:
i) Recruit one or more remote agents from the plurality of remote agents for selection for a client user dedicated pool from the plurality of remote agents;
ii) Select the client user dedicated pool; and
iii) Directly manage the provision of service communications by the client user dedicated pool via the remote agent network.

2) The method of claim 1, further comprising the step of providing access to the one or more client users to a labor exchange that enables the one or more client users to:
a) Record eligibility requirements for selection of remote agents as part of the client user dedicated pool;
b) Define the contents of forms to be completed by remote agents in order to be eligible for selection as part of the client user dedicated pool; and
c) Review the contents of the forms as part of a decision whether or not to select a particular remote agent as part of the client user dedicated pool.

3) The method of claim 2, further comprising the steps of:
a) Soliciting the submission of e-resumes by one or more remote agents in order to be eligible for selection as part of the client user dedicated pool; and
b) Comparison of the content of the forms and/or the e-resumes with the eligibility requirements to define a list of potential remote agents for review by the one or more client users.

4) The method of claim 3, comprising the further step of enabling the one or more client users to contact remote agents from the list of potential remote agents to arrange interviews.

5) The method of claim 1, further comprising the step of providing secure access to remote agents selected as forming part of the client user dedicated pool to one or more client user call center applications and related client user data in support of the provision of service communications by the dedicated pool of remote agents.

6) The method claimed in claim 1, further comprising the step of enabling the one or more client users to control the remote agent state on a carrier switch.

7) The method claimed in claim 6, further comprising the step of enabling a remote agent to log in to a telephony server and thereby queue to a client user call queue on the carrier switch via a telephony application.

8) The method claimed in claim 7, comprising the further step of authenticating the remote agent before permitting the remote agent to log on to the telephony server.

9) The method claimed in claim 1, further comprising the step of loading computer programming on a client computer associated with a remote agent, the computer programming being configured to create a secure partition between client data accessed by the remote agent and the hard drive of the client computer.

10) The method claimed in claim 1, further comprising the step of providing access to the one or more client users and the client user dedicated pool to a payment utility that enables tracking of service communications completed by the client user dedicated pool, billing of completed service communications to the one or more client users, and payment for completed service communications to members of the client user dedicated pool.

11) A system for engaging a plurality of individuals for the provision of service communications to customers of one or more client users, the system comprising:
a) A communication platform;
b) A web server linked to the communication platform and adapted to provide a secure connection to a client server, wherein the client server includes one or more call center applications and is linked to a client database including service communication data; and
c) A telephony server linked to the communication platform, a carrier switch and the web server, wherein the telephony server and web server cooperate to enable one or more client users to permit access to a dedicated pool of remote agents selected by the one or more client users to access:
i) The client server; and
ii) And a call queue from the carrier switch, thereby enabling the dedicated pool of remote agents to take calls from the call queue from one or more remote devices.

12) The system as claimed in claim 11, wherein the web server includes a network application that enables the one or more client users to:
a) Recruit one or more remote agents from the plurality of remote agents for selection for a client user dedicated pool from the plurality of remote agents;
b) Select the client user dedicated pool; and
c) Directly manage the provision of service communications by the client user dedicated pool via the remote agent network.

13) The system as claimed in claim 12, wherein the network application enables the configuration of one or more client user work centers and remote agent work centers, wherein the work centers provide access to the one or more client users and to the remote agents respectively to a series of utilities for remote agents providing service communications, and for the one or more client users managing the provision of such service communications by remote agents.

14) A computer program for operation on a web server linked to a telephony server and a communication platform, the computer program defining a network application that provides instructions for enabling one or more client users to permit access to a dedicated pool of remote agents selected by the one or more client users to access:
a) a client server that includes one or more call center applications and is linked to a client database including service communication data; and
b) the telephony server so as to establish a link to a client user call queue from a carrier switch, thereby enabling the dedicated pool of remote agents to take calls from the call queue from one or more remote devices thereby enabling the remote agents to provide service communication services to the one or more client users.

15) A computer program as claimed in claim 14, wherein the network application enables client users to
a) Recruit one or more remote agents from the plurality of remote agents for selection for a client user dedicated pool from the plurality of remote agents;
b) Select the client user dedicated pool; and
c) Directly manage the provision of service communications by the client user dedicated pool via the remote agent network.

16) A computer program as claimed in claim 14, wherein the network application enables the configuration of one or more client user work centers and remote agent work centers, wherein the work centers provide access to client users and remote agents respectively to a series of utilities for remote agents providing service communications, and for the one or more client users managing the provision of such service communications by the remote agents.

17) A computer program as claimed in claim 16, wherein the network application enables the one or more client users to define a custom interface for provision of service communications by the remote agents.

18) A computer program as claimed in claim 17, wherein the network application provides access to client user managers and to the remote agents to a series of collaboration utilities, work scheduling utilities and communication utilities.

19) A computer program as claimed in claim 18, wherein the network application includes an intelligent transaction router that is adapted to route client user calls from the carrier switch to the dedicated pool of remote agents based on rules defined by the one or more client users for handling of their service communications, and the logged in status to the communication platform of specific remote agents forming part of the dedicated pool.

20) A computer program as claimed in claim 14, wherein the network application is linked to a billing application that enables tracking of service communications completed by the client user dedicated pool, billing of completed service communications to the one or more client users, and payment for completed service communications to members of the client user dedicated pool.

21) A computer program as claimed in claim 14, wherein the network application includes a database management utility linked to a database, wherein the document management utility enables the creation and management of data including documents used by remote agents in the provision of service communications.

22) A computer program as claimed in claim 14, wherein the network application includes a web emulator for providing operable emulation of client user call center applications to the dedicated pool of remote agents from client computers of such dedicated pool of remote agents.

23) A computer program for operation on a client computer associated with a remote agent selected by one or more client users to form part of a dedicated pool of remote agents for providing service communications to the one or more client users, the computer program defining a client application that provides instructions to the client computer to:
a) Load into the RAM of the client computer an operating platform;
b) Establish a secure partition between the client computer hard drive and client user data accessed by the client computer in the provision of service communications; and
c) Establish IP packet control of the client computer state on a carrier switch.

24) The computer program claimed in claim 23, wherein the client application is adapted to configure the client computer to provide a VPN secure remote workstation connected to a remote agent network that includes a communication platform, a web server connected to the communication platform, and a telephony server connected to the web server and the communication platform, wherein the remote agent network enables the provision of service communications by the dedicated pool of remote agents.

25) The computer program claimed in claim 24, wherein the client application is adapted to connect the client computer to the remote agent network, thereby establishing a secure connection between the client computer and a client server linked to the client users, the client server including one or more call center applications and related client user data.

26) The computer program claimed in claim 24, wherein the client application further includes an authentication facility for authenticating the remote agent prior to providing access to the client server.

27) The computer program claimed in claim 26, wherein the authentication facility is adapted to interface with a bioauthentication device connected to the client computer so as to verify the identity of the remote agent prior to providing access to the client server.

28) A system comprising:
a) a client computer associated with a remote agent selected by one or more client users to form part of a dedicated pool of remote agents for providing service communications to the one or more client users; and
b) a computer program loaded on the client computer, the computer program providing a client application that provides instructions to the client computer to:
i) Load into the RAM of the client computer an operating platform;
ii) Establish a secure partition between the client computer hard drive and client user data accessed by the client computer in the provision of service communications; and
iii) Establish IP packet control of the client computer state on a carrier switch.

29) The system as claimed in claim 28, wherein the client application is adapted to configure the client computer to provide a VPN secure remote workstation connected to a remote agent network that includes a communication platform, a web server connected to the communication platform, and a telephony server connected to the web server and the communication platform, wherein the remote agent network enables the provision of service communications by the dedicated pool of remote agents.

30) The system as claimed in claim 29, wherein the client application is adapted to connect the client computer to the remote agent network, thereby establishing a secure connection between the client computer and a client server linked to the client users, the client server including one or more call center applications and related client user data.
